(19) United States
(12) Patent Application Publication
(10) Pub. No.: US 2022/0153403 A1
(43) Pub. Date: May 19, 2022

(54) WINGED AIRCRAFT

(71) Applicant: THE ROYAL VETERINARY COLLEGE, London (GB)

(72) Inventors: Richard BOMPHREY, London (GB); James USHERWOOD, London (GB); Jorn CHENEY, London (GB); Shane WINDSOR, London (GB); Jonathan STEVENSON, London (GB); Nicholas DURSTON, London (GB)

(73) Assignee: THE ROYAL VETERINARY COLLEGE, London (GB)

(21) Appl. No.: 17/440,304

(22) PCT Filed: Mar. 19, 2020
(86) PCT No.: PCT/GB2020/050722

§ 371 Date: Sep. 17, 2021

(30) Foreign Application Priority Data
Mar. 20, 2019 (GB) 1903806.6

(51) Int. Cl. B64C 3/42; B64C 39/02

(52) U.S. Cl. CPC B64C 3/42; B64C 39/024; B64C 2201/127; B64C 2201/021; B64C 2201/123; B64C 2201/102

(57) ABSTRACT

The present disclosure provides an aircraft (10) for flying in a forward direction (F). The aircraft (10) comprises an aircraft body (20), and a wing comprising a first wing portion (30A) and a second wing portion (30B). The first wing portion (30A) and the second wing portion (30B) extend away from the aircraft body (20). The first wing portion (30A) and the second wing portion (30B) are configured to generate a first lift value during level flight of the aircraft (10) in the forward direction (F) when the first wing portion (30A) and the second wing portion (30B) are in an equilibrium position. Each of the first wing portion (30A) and the second wing portion (30B) is flexibly mounted relative to the aircraft body (20) such that when a lift force generated by the first wing portion (30A) changes from the first lift value to a second lift value, the first wing portion (30A) is deflected substantially vertically away from an equilibrium position. The aircraft (10) is configured to provide a further force to the first wing portion (30A) to substantially prevent further deflection of the first wing portion (30A) away from the equilibrium position.

This invention relates to an aircraft, and in particular to a winged aircraft for flying in a forward direction.

### BACKGROUND

Aircraft continue to be of immense utility, both in providing transportation of people and goods, and also in providing a platform for observation. Indeed, some of the earliest uses of aircraft in military conflict were as elevated surveillance platforms from which an occupant could photograph a landscape below. Typically, most aircraft now have one or more sensors on-board for capturing data indicative of an environment of the aircraft, such as nearby airspace, or on the ground. The one or more sensors can include one or more cameras, a radar sensor, a thermal imaging sensor, among others.

A more recent development has been the miniaturisation of aircraft for ease of transport between flights and for operation in more space-restricted areas, as well as decreasing the observability/noticeability of the aircraft. This advance has been enabled by the development of advanced control systems, either allowing an aircraft to be reliably and safely piloted remotely, or for at least some of the operations of the aircraft to be performed autonomously, for example based on processing performed by a computerised controller situated on-board the aircraft. Without the need for a pilot on board, aircraft no longer need to be able to carry at least the mass of the pilot. Aircraft without people, such as a pilot, on board are sometimes referred to as “Unmanned Aerial Vehicles” (UAVs).

It will be understood that where aircraft are smaller, perturbations in the airflow conditions through which the aircraft is flying will have a greater effect on the flight characteristics of the aircraft.

In particular, gusts present a challenging situation for small aircraft, both in terms of stable control of the aircraft, but also in terms of providing a stable platform, for example for operation of the sensor(s) on-board the aircraft, for the operation of targeted emitters on-board the aircraft or for the transportation of delicate cargo. One potential solution to the problem of providing a stable platform on-board the aircraft is to use gyroscopic stabilisation systems for mounting the portion of the aircraft to be stabilised to the aircraft, for example the sensor(s). The smaller the aircraft, the more significant an effect a gust can have on the movement of the aircraft. This means small aircraft typically require large, heavy, complicated, power-consuming and/or expensive gyroscopic stabilisation systems to provide a stable portion of the aircraft.

It is in this context that the present invention has been devised.

### BRIEF SUMMARY OF THE DISCLOSURE

In accordance with the present disclosure there is provided an aircraft for flying in a forward direction. The aircraft comprises: an aircraft body; and a wing comprising a first wing portion and a second wing portion. Each of the first wing portion and the second wing portion extends away from the aircraft body. The first wing portion and the second wing portion are configured to generate a first lift value during level flight of the aircraft in the forward direction when the first wing portion and the second wing portion are in an equilibrium position. Each of the first wing portion and the second wing portion is flexibly mounted relative to the aircraft body such that when a lift force generated by the first wing portion changes from the first lift value to a second lift value, the first wing portion is deflected substantially vertically away from an equilibrium position. The aircraft is configured to provide a further force to the first wing portion to substantially prevent further deflection of the first wing portion away from the equilibrium position.

Thus, the aircraft body can have a reduced response to gusts incident on the wing portions of the aircraft. By ensuring that the mounting between the wing portions and the aircraft body is flexible, the wing portions can move more freely relative to the aircraft body during flight, which reduces coupling between movement of the wing portions and movement of the aircraft body. As a result, the aircraft body can provide a more stable platform for mounting sensors thereto, for mounting emitters thereto, or for transporting delicate cargo. Further stabilising components are not required, or can be significantly less complex, less expensive, less power-consuming and/or have less mass compared with the stabilisation components required on a similar aircraft having wing portions of the wing rigidly connected to the aircraft body.

Although the present disclosure describes the wing comprising the first wing portion and the second wing portion, it will be understood that each of the first wing portion and the second wing portion of the wing can sometimes be notionally referred to as a first wing and a second wing, for example a port-side wing and a starboard-side wing. It will be understood that the wing portions described herein can sometimes be referred to as wing semi-spans.

The second wing portion may be flexibly mounted relative to the aircraft body such that when a lift force generated by the second wing changes from the first lift value to the second lift value, the second wing portion is deflected substantially vertically away from the equilibrium position. The aircraft may be configured to provide the further force to the second wing portion to substantially prevent further deflection of the second wing portion away from the equilibrium position.

Each of the first wing portion and the second wing portion may have a wing root and a wing tip, and a wing length defining a distance between the wing root and the wing tip in the along-wing direction. The first wing portion may be configured such that, during flight, a distance between a centre of percussion of the first wing portion and a centre of pressure of the first wing portion in the along-wing direction is less than 25% of the wing length. The distance may be less than 15%. The distance may be less than 10%. The distance may be less than 5%. Thus, reaction forces at the wing root caused by gusts are significantly reduced if not substantially eliminated. As used herein, the term “centre of percussion” will be understood to mean the point on the wing portion at which an impulse applied to the wing portion, substantially normal to the surface of the wing portion, will cause no reaction force at the mounting between the wing portion and the aircraft body. The mounting between the wing portion and the aircraft body is typically located at the wing root. By arranging the structure of the wing portion in this way, immediate reaction forces on the aircraft body can be significantly reduced, if not eliminated, even if the aircraft body moves more gradually to respond to the change in lift generated by the wing portions. Thus, the stabilisation requirements for any delicate portions of the aircraft body (such as sensors, emitters or delicate cargo) can be significantly reduced or even substantially eliminated.

Each of the first wing portion and the second wing portion may be configured such that a first distance between the centre of percussion of the respective wing portion and the wing root is less than a second distance between the centre of pressure of the respective wing portion and the wing root. In other examples, each wing portion may be configured such that a first distance between the centre of percussion of the respective wing portion and the wing root is greater than a second distance between the centre of pressure of the respective wing portion and the wing root. In this case, it will be understood that the centre of percussion may be configured to move towards the wing root as the wing portion is deflected if the further force varies in dependence to (for example increases in proportion to) the deflection of the wing.

The first wing portion may be configured such that the centre of percussion is substantially co-located with the centre of pressure of the first wing portion. The second wing portion may be configured such that the centre of percussion is substantially co-located with the centre of pressure of the second wing portion.

The aircraft may define a longitudinal axis between a nose and a tail of the aircraft. The first wing portion may be pivotably mounted relative to the aircraft body about a pivot axis substantially parallel to the longitudinal axis and at a wing root of the first wing portion. The second wing portion may be pivotably mounted relative to the aircraft body about a pivot axis substantially parallel to the longitudinal axis and at a wing root of the second wing portion. The further force for the first wing portion may be provided when the first wing portion is rotated about the pivot axis away from the equilibrium position. The further force for the second wing portion may be provided when the second wing portion is rotated about the pivot axis away from the equilibrium position.

Thus, the wing portions can be flexibly mounted to the aircraft body by means of a pivotable connection about the pivot axis.

The aircraft may further comprise at least one rotation stop configured to substantially constrain rotation of the first wing portion about the pivot axis to be within a predetermined rotation range. The at least one rotation stop may be configured to substantially constrain rotation of the second wing portion about the pivot axis to be within a predetermined rotation range. Thus, the wing portions can be prevented from rotating too far from the equilibrium position, allowing the aircraft to continue to be controllable, even in gusty conditions, or during high lift manoeuvres such as take-off and banked turns. The at least one rotation stop may comprise a first, for example an upper portion to substantially constrain rotation of the first wing portion about the pivot axis in the upwards direction such that a centre of mass of the first wing portion is prevented from exceeding an upper predetermined height relative to the aircraft body. The at least one rotation stop may comprise a second, for example a lower portion to substantially constrain rotation of the first wing portion about the pivot axis in the downwards direction such that a centre of mass of the first wing portion is prevented from going below a lower predetermined height relative to the aircraft body. The at least one rotation stop may comprise a first, for example an upper portion to substantially constrain rotation of the second wing portion about the pivot axis in the upwards direction such that a centre of mass of the second wing portion is prevented from exceeding an upper predetermined height relative to the aircraft body. The at least one rotation stop may comprise a second, for example a lower portion to substantially constrain rotation of the second wing portion about the pivot axis in the downwards direction such that a centre of mass of the second wing portion is prevented from going below a lower predetermined height relative to the aircraft body. Thus, the wing portions can be protected from over-rotation, for example during take-off or landing.

The further force may be a balancing force to substantially prevent any further deflection of the first wing portion away from the equilibrium position when the lift force generated by the first wing portion returns to the first lift value. Thus, when the aircraft has finished travelling through the gusty region, the first wing portion will no longer continue to deflect away from the equilibrium position.

The balancing force may substantially prevent any further deflection of the second wing portion away from the equilibrium position when the lift force generated by the second wing portion returns to the first lift value.

The further force may be a restoring force to move the first wing portion back towards the equilibrium position when the lift force generated by the first wing portion returns towards the first lift value. Thus, the first wing portion can be moved back towards the equilibrium position when the aircraft has finished travelling through the gusty region.

The further force may be a restoring force to move the second wing portion back towards the equilibrium position when the lift force generated by the second wing portion returns towards the first lift value.

The aircraft may further comprise at least one resiliently deformable member connecting the aircraft body to the first wing portion and configured to provide the restoring force. Thus, the resiliently deformable member can act to return the first wing portion to the equilibrium position.

The aircraft may further comprise at least one resiliently deformable member connecting the aircraft body to the at the second wing portion and configured to provide the restoring force.

The further force may be configured to change a lift force generated by the first wing portion from the second lift value towards and past the first lift value to return the first wing portion back towards the equilibrium position. Thus, a lift generated by the first wing portion can be modified in gusty conditions to ensure the aircraft body remains stable. The further force may be configured to change a lift force generated by the first wing portion to a third lift value. The first lift value may be between the third lift value and the second lift value.

The further force may be configured to change a lift force generated by the second wing portion from the second lift value towards and past the first lift value to return the second wing portion back towards the equilibrium position.

The aircraft may be configured to provide a second further force to the first wing portion as the first wing portion returns to the equilibrium position to change the lift force generated by the first wing portion to the first lift value. Thus, the first wing portion can be maintained substantially in the equilibrium position, potentially even while the aircraft is still in a different air region, such as in a gust. The further force may be configured to be applied to the first wing portion to change an angle of attack of the first wing portion, whereby to change the lift generated by the first wing portion.

The aircraft may be configured to provide a second further force to the second wing portion as the second wing portion returns to the equilibrium position to change the lift force generated by the second wing portion to the first lift value.

The aircraft may further comprise one or more sensors, mounted at the aircraft body. The one or more sensors may comprise at least one of a camera, a thermal imaging sensor and a radar sensor.

The aircraft may comprise one or more emitters, mounted at the aircraft body. The one or more emitters may comprise a sound emitter. The one or more emitters may comprise a radiation emitter. The radiation emitter may be a laser. The one or more emitters may comprise a matter emitter.

The aircraft may comprise one or more components for landing, such as a landing wire or a landing hook, mounted at the aircraft body.

The aircraft may further comprise a locking mechanism configured to, when activated, secure the first wing portion in the equilibrium position. In this way, the locking mechanism can prevent deflection of the first wing portion away from the equilibrium position. The locking mechanism can be configured to be activated when manoeuvrability of the aircraft is required. The locking mechanism can be configured to be activated for at least one of a landing operation and a take-off operation of the aircraft. The aircraft may further comprise a locking mechanism configured to, when activated, secure the second wing portion in the equilibrium position

The locking mechanism may comprise a locking spar configured to selectively extend between the first wing portion and the aircraft body to substantially prevent deflection of the first wing portion away from the equilibrium position. The locking spar may be in the form of a bolt. The locking spar may be configured to selectively extend from the first wing portion towards the aircraft body. Alternatively, the locking spar may be configured to selectively extend from the aircraft body towards the first wing portion.

The aircraft may further comprise one or more further components, located in the first wing portion. Thus, a mass of the first wing portion relative to the aircraft body can be increased, which can be used to manipulate a location of the centre of percussion of the first wing portion. Locating one or more components proximal to the wing root of the first wing portion can move the centre of percussion of the first wing portion closer to the wing root. Similarly, locating one or more components proximal to the wing tip of the first wing portion can move the centre of percussion of the first wing portion closer to the wing tip. Furthermore, it has been found that where the first wing portion has a higher mass, it will be rotated less by a given gust speed. As a result, more massive wings can increase the upper gust speed limit for which the aircraft can operate within an acceptable rotation range of the first wing portion. The one or more further components may be provided at a distance approximately 30% from the wing root to the wing tip. Thus, the one or more further components are located at the position in the first wing portion having the greatest effect on the centre of percussion of the first wing portion.

The one or more further components may be located in the second wing portion. The one or more further components may be components not essential to be located in the first wing portion. The one or more further components may comprise at least one of batteries, control systems, communication systems and non-delicate cargo areas.

The wing including the first wing portion and the second wing portion may be configured to be at least 40% of the total mass of the aircraft. The wing may be configured to be at least 50% of the total mass of the aircraft. Thus, the additional relative mass of the wing to the aircraft body can improve the gust performance of the aircraft.

The further force may be passively provided. Thus, no active response or control system is required in the aircraft, reducing costs, weight, power consumption and complexity of the aircraft.

In some embodiments, at least a portion of each wing may be configured to pitch about an axis running along the along-wing direction. Thus, an angle of attack of the wings can be varied in order to vary the lift generated by the wings.

The aircraft may be a powered aircraft. The aircraft may be a glider. Although not described herein, it will be understood that the concepts disclosed herein may apply to rotary aircraft as well as winged aircraft.

The aircraft may comprise exactly two wing portions. The first wing portion and the second wing portion may extend substantially horizontally from the aircraft body in the equilibrium position.

The aircraft may comprise at least one balancing component, for example at least one resiliently deformable component for each wing portion. The aircraft may comprise exactly one resiliently deformable component for each wing portion. The resiliently deformable component may comprise a spring. The spring may be a torsion spring. The resiliently deformable component may be resiliently extensible. The resiliently deformable component may be a resiliently extensible cord, for example a bungee cord or similar, such as a cord comprising an elastic material.

Each wing portion may comprise a mounting point for attachment thereto of the at least one resiliently deformable component.

Each wing portion may be mounted to the aircraft body separate from the resiliently deformable member.

The aircraft may be less than 6,000 kilograms. The aircraft may be less than 1,000 kilograms. The aircraft may be less than 500 kilograms. The aircraft may be less than 100 kilograms. The aircraft may be less than 50 kilograms. The aircraft may be less than 20 kilograms. The aircraft may be less than 10 kilograms. The aircraft may be less than 5 kilograms. The aircraft may be less than 1 kilogram.

The aircraft may have a wingspan of less than 30 metres. The aircraft may have a wingspan of less than 15 metres. The aircraft may have a wingspan of less than 5 metres. The aircraft may have a wingspan of less than 2 metres. The aircraft may have a wingspan of less than 1 metre. The aircraft may have a wingspan of less than 30 centimetres.

The aircraft may be an unmanned aerial vehicle, sometimes referred to as a UAV.

The present disclosure extends to a kit of parts for assembling the aircraft. The kit comprises: the aircraft body as described hereinbefore; and a first wing portion and a second wing portion as described hereinbefore and each configured to be attached to the aircraft body to extend away from the aircraft body for generating a first lift value during level flight of the assembled aircraft in the forward direction when the first wing portion and the second wing portion are in an equilibrium position. Each of the first wing portion and the second wing portion is configured to be flexibly mounted relative to the aircraft body such that when a lift force generated by the first wing portion changes from the first lift value to a second lift value, the first wing portion is deflected substantially vertically away from the equilibrium position. The assembled aircraft is configured to provide a further force to the first wing portion to substantially prevent further deflection of the first wing portion away from the equilibrium position.

### BRIEF DESCRIPTION OF THE DRAWINGS

Embodiments of the invention are further described hereinafter with reference to the accompanying drawings, in which:

FIG. 1 is an illustration of an aircraft as disclosed herein, viewed from a head-on orientation;

FIGS. 2 and 3 are illustrations of the aircraft as shown in FIG. 1, viewed from a side-on orientation and a top-down orientation respectively; and

FIGS. 4 and 5 are further illustrations of the aircraft shown in FIGS. 1 to 3, provided in a perturbed configuration and viewing in a head-on and side-on orientation respectively.

### DETAILED DESCRIPTION

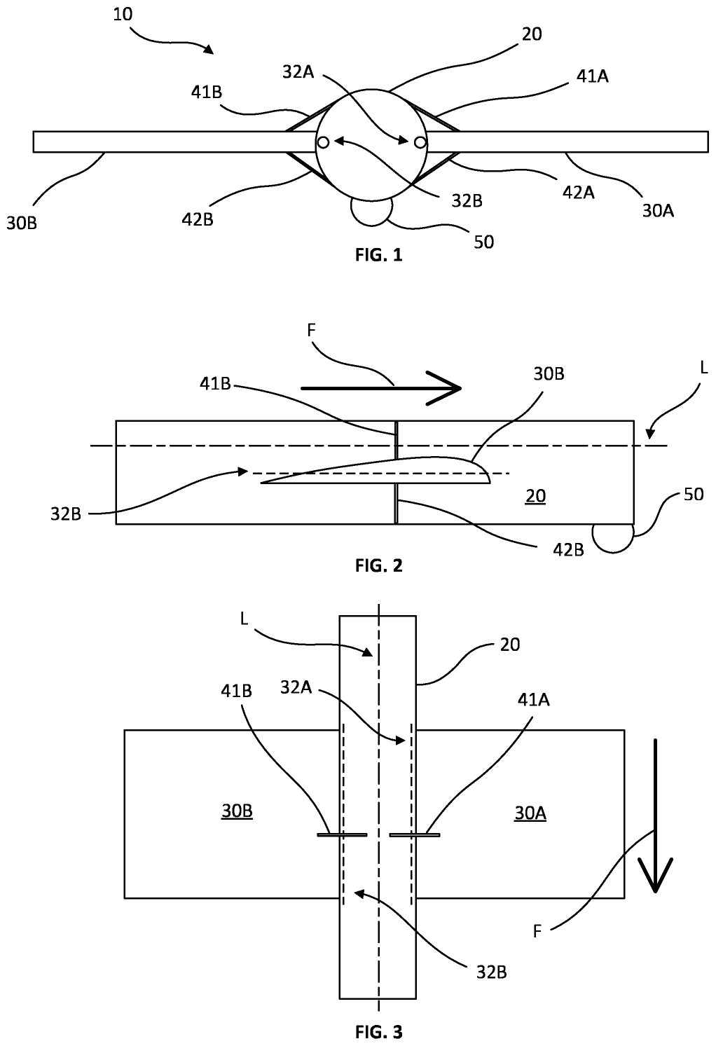

FIGS. 1 to 5 shown a diagrammatic illustration of an aircraft 10. FIG. 1 shows the aircraft 10 viewed from a head-on or nose-on orientation. The aircraft 10 may be powered or non-powered, i.e. a glider. Where the aircraft 10 is powered, it may be powered by substantially any propulsion system suitable for causing relative movement of one or more lift-generating portions the aircraft 10 through the air, for example a propeller, a jet engine or any other suitable propulsion system. Typically, the aircraft 10 is an unamanned aircraft, sometimes referred to as an unmanned aerial vehicle (UAV). The aircraft 10 comprises an aircraft body 20 in the form of a fuselage 20. As better described with reference to FIG. 2 hereinafter, the aircraft 10 defines a longitudinal axis (labelled as L in FIGS. 2 and 3) between a nose and a tail of the aircraft 10. In some examples, the tail of the aircraft 10 does not correspond to a particular aerodynamic component of the aircraft 10, but is simply a rear of the aircraft 10 when the aircraft 10 is flying in a forward direction. In other examples, the tail of the aircraft can be an aerodynamic component of the aircraft 10, arranged to provide aerodynamic stability during flight of the aircraft 10, including pitch control of the aircraft 10. It will be understood that many different designs of tail aerodynamic components are known for aircraft 10, and an appropriate design can be chosen by the designer of the aircraft 10 without departing from the inventive concepts disclosed herein. Similarly, the nose of the aircraft is typically a front of the aircraft 10 when the aircraft 10 is flying in the forward direction. In this way, it can be seen that the longitudinal axis of the aircraft 10 is substantially aligned with a direction of flight of the aircraft 10. For simplicity, note that any tail and nose of the aircraft 10 depicted in the figures of the present disclosure have not been shown. The aircraft 10 further comprises a wing comprising a first wing portion 30A and a second wing portion 30B. The first wing portion 30A extends away from the aircraft body 20. The second wing portion 30B extends away from the aircraft body 20. The first wing portion 30A extends away from the aircraft body 20 in a first along-wing direction. The second wing portion 30B extends away from the aircraft body in a second along-wing direction, different from the first along-wing direction. In this example, the first wing portion 30A extends substantially opposite the second wing portion 30B. Each of the first wing portion 30A and the second wing portion 30B has a wing root at which the respective wing portion 30A, 30B is connected to the aircraft body 20, and a wing tip distal from the wing root and the aircraft body 20. As is customary, the wing portions 30A, 30B each generate lift as a result of movement of the aircraft 10 in the forward direction relative to the local atmosphere. This can be referred to as flight. Each wing portion 30A, 30B is flexibly mounted relative to the aircraft body 20. In this example, the first wing portion 30A is pivotably mounted relative to the aircraft body 20 about a first wing pivot axis 32A substantially parallel to a longitudinal axis of the aircraft body 20 and to the longitudinal axis of the aircraft 10. Similarly, the second wing portion 30B is pivotably mounted relative to the aircraft body 20 about a second wing pivot axis 32B substantially parallel to the longitudinal axis of the aircraft body 20 and to the longitudinal axis of the aircraft 10. The longitudinal axis of the aircraft body 20 is substantially aligned with the forward direction of flight of the aircraft 10 in which the wings 30A, 30B are arranged to generate lift. In other words, the wing portions 30A, 30B are arranged to roll relative to the aircraft body 20 when pivoting about the first wing pivot axis 32A or the second wing pivot axis 32B. It will be understood that an increase in lift generated by the wing portions 30A, 30B will impart a greater upward force on the wing portions 30A, 30B, which can cause rotation of the wing portions 30A, 30B about the respective pivot axes 32A, 32B in a direction such that a centre of gravity of each of the wing portions 30A, 30B is raised. Similarly, a decrease in lift generated by the wing portions 30A, 30B will impart a lesser upward force on the wing portions 30A, 30B, which can cause rotation of the wing portions 30A, 30B about the respective pivot axes 32A, 32B in a direction such that a centre of gravity of each of the wing portions 30A, 30B is lowered. In level flight of the aircraft 10 in the forward direction F, with the first wing portion 30A and the second wing portion 30B each in an equilibrium position, the first wing portion and the second wing portion are each configured to generate a first lift value. When the lift force generated by the first wing portion 30A or the second wing portion 30B changes to a second lift value, the respective first wing portion 30A or the second wing portion 30B is deflected substantially vertically away from the equilibrium position. It will be understood that the equilibrium position of the wing portions 30A, 30B can vary in dependence on the airspeed of the aircraft 10, as well as the lift profile of the wing portions 30A, 30B and other factors. In this example, the pivot axes 32A, 32B are each located substantially at the wing root of each wing portion 30A, 30B. It will be understood that the first wing portion 30A and the second wing portion 30B can move independently of each other. In other words, if only the first wing portion 30A encounters a change in lift, then the first wing portion 30A may deflect, whereas the second wing portion 30B may not deflect.

The aircraft 10 is configured such that when the first wing portion 30A or the second wing portion 30B is deflected away from the equilibrium position, a further force is generated to substantially prevent further deflection of the respective first wing portion 30A or the second wing portion 30B away from the equilibrium position. In one example, the aircraft 10 comprises balancing components 41A, 41B, 42A, 42B in the form of upper balancing components 41A, 41B configured to impart an upward force on the wing portions 30A, 30B, and lower balancing components 42A, 42B configured to impart a downward force on the wing portions 30A, 30B. In this way, the balancing components 41A, 41B, 42A, 42B can be understood to be providing a balancing force to the wing portions 30A, 30B to substantially prevent any further deflection of the wing portions 30A, 30B away from the equilibrium position when the lift force generated by each of the wing portions 30A, 30B returns from the second lift value to the first lift value. Until the lift force returns exactly to the first lift value, the wing portions 30A, 30B may continue to deflect away from the equilibrium position. In the equilibrium position, during normal flight, it will be understood that the moments caused at the root of the wings 30A, 30B by the lifting force from the wings 30A, 30B and the upward force imparted by the upper balancing components 41A, 41B are substantially balanced by the moments caused at the root of the wings 30A, 30B by the weight of the wings 30A, 30B and the downward force imparted by the lower balancing components 42A, 42B. In this way, the wings 30A, 30B are configured to be substantially stationary during normal flight in the equilibrium position. In other words, the forces supplied by the balancing components 41A, 41B, 42A, 42B are configured to be sufficient to cause the wing portions 30A, 30B to stay in the equilibrium position during normal flight. Typically, the equilibrium position of the wing portions 30A, 30B is substantially horizontal, this representing the position in which the lift generated by the wings is maximised by virtue of a maximised projected surface area of the wing portions 30A, 30B on a ground plane. In this example, the vertical forces supplied by the balancing components 41A, 41B, 42A, 42B to the wing portions 30A, 30B are configured to be substantially independent of the amount of deflection of the wing portions 30A, 30B. Nevertheless, it will be understood that, in practice, the force supplied by the balancing components 41A, 41B, 42A, 42B may vary at least slightly in dependence on a extension of the balancing components 41A, 41B, 42A, 42B. For example, the force supplied by the balancing components 41A, 41B, 42A, 42B can increase with an increase in the length of the balancing components 41A, 41B, 42A, 42B. In this way, the balancing components 41A, 41B, 42A, 42B can sometimes be referred to as resiliently deformable components 41A, 41B, 42A, 42B which can be configured to revert to their original size and shape following any deformation of the resiliently deformable components 41A, 41B, 42A, 42B. In this case, the aircraft 10 can be considered to move the first wing portion 30A and the second wing portion 30B back towards the equilibrium position when the lift force generated by the first wing portion 30A or the second wing portion 30B, respectively, returns from the second lift value towards the first lift value. Thus, the wing portions 30A, 30B can move back towards the equilibrium portion before the lift force has actually reached the first lift value. In this way, the further force can sometimes be referred to as a restoring force. A damping component may be provided as part of each resiliently deformable component 41A, 41B, 42A, 42B, whereby to reduce variation in the further force applied to the wing portions 30A, 30B by the resiliently deformable components 41A, 41B, 42A, 42B. In other words, the damping component can have the effect of reducing the resultant velocity of the wing portions 30A, 30B during deflection of the wing portions 30A, 30B.

On encountering a gust of wind, or other cause of a sudden variation in the lift generated by one or both of the wing portions 30A, 30B, the wing portions 30A, 30B can flexibly move, for example can pivot about the pivot axes 32A, 32B, which will reduce the resulting movement of the aircraft body 20, or at least spread the movement out over a longer time period such that any resulting movement of the aircraft body 20 is less severe. Viewed another way, the movement of the wing portions 30A, 30B can compensate, at least partially, for the change in lift caused by the gust of wind.

The balancing components 41A, 41B, 42A, 42B in this example can be provided by elasticated cords, springs or other resiliently deformable components which can connect a region of each wing portion 30A, 30B to a further component, such as the aircraft body 20. The first wing portion 30A is independently connected to the aircraft body 20 via a first upper balancing component 41A and separately via a first lower balancing components 42A. The second wing portion 30B is independently connected to the aircraft body 20 via a second upper balancing component 41B and separately via a second lower balancing components 42B. The balancing components 41A, 41B, 42A, 42B are connected to the wing portions 30A, 30B away from the wing root and away from the pivot axes 32A, 32B to allow each of the balancing components 41A, 41B, 42A, 42B to apply a rotational moment to the wing portions 30A, 30B acting about the pivot axes 32A, 32B. In this way, it can be seen that the balancing components 41A, 41B, 42A, 42B provide a passive solution to dealing with gusts without requiring any additional active monitoring or control of the wing portions 30A, 30B. Of course, it will be understood that the aircraft 10 may additionally include one or more active measures for mitigating the effects of gusts on the aircraft body 20.

Although not shown, it will be understood that each wing portion 30A, 30B is provided with one or more mounting points thereon for the attachment thereto of the balancing components 41A, 41B, 42A, 42B of the type shown in the Figures. The one or more mounting points can be located substantially anywhere along the wing portions 30A, 30B between the wing root and the wing tip of each respective wing portion 30A, 30B.

Although the aircraft 10 shown in FIG. 1 has both upper balancing components 41A, 41B and lower balancing components 42A, 42B connected to the wing portions 30A, 30B, it will be understood that in other examples, a different number, configuration or even type of balancing components can be provided to generate the further force when the wing portions 30A, 30B are deflected away from the equilibrium position. For example, only the upper balancing components 41A, 41B may be provided. Although, the balancing components can be configured as resiliently deformable components such that the further force generated is a restoring force and is proportional, for example directly proportional, to the length of extension of the balancing component, it is preferred that the balancing components 41A, 41B, 42A, 42B apply a substantially unvarying vertical force to the wing portions 30A, 30B on deflection of the wing portions 30A, 30B. When a restoring force is generated, a reduction in the length of the upper resiliently deformable components 41A, 41B caused by movement of the wing portions 30A, 30B upwards (for example due to a gust creating a temporary increase in lift), will reduce the upward components of the force applied by the upper resiliently deformable components 41A, 41B, which effectively results in a downward restoring force being applied to the wing portions 30A, 30B, which will act to move the wing portions 30A, 30B back down to the equilibrium position. In a similar way, it will be appreciated that only the lower balancing components 42A, 42B may be provided. In yet further examples, the balancing components can take any alternative form as long as a force is generated when the wing portion 30A, 30B is deflected away from the equilibrium position whereby to prevent further deflection of the wing portion 30A, 30B when the cause of the wing deflection, e.g. the gust, is removed. In this way, the aircraft 10 can be configured to allow the wing portions 30A, 30B to flexibly deflect at each mounting between the respective wing portions 30A, 30B and the aircraft body 20 to at least delay or reduce the severity of a response of the aircraft body 20 to a gust impacting on the aircraft 10 during flight. Preferably, the response of the aircraft body 20 to the gust is substantially eliminated.

It will be understood that the wing portions 30A, 30B are configured to be flexibly mounted to the aircraft body 20 during at least a period of normal flight of the aircraft 10 in order for this feature to mitigate at least partially against the effect of gusts.

It will be understood that as well as the wing portions 30A, 30B being flexibly mounted relative to the aircraft body 20, the wing portions 30A, 30B themselves may also be formed to have a flexible structure. In other words, the wing portions 30A, 30B can be arranged to flex, which can further mitigate the transmission of any effect of gusts from the wing portions 30A, 30B to the aircraft body 20.

The inventors have realised that by making the wing portions 30A, 30B flexibly mounted relative to the aircraft body 20, fewer movements of the wing portions 30A, 30B, for example due to changes in the lift generated as a result of gusts, will be transferred to the aircraft body 20. In contrast, where the wing portions 30A, 30B are rigidly mounted to the aircraft body 20, movements in the wing portions 30A, 30B are more readily transferred to the aircraft body 20, even when the wing portions 30A, 30B themselves are configured to flex.

The aircraft body 20 is a substantially non-lifting body. In other words, at least the majority of lift for the aircraft 10 comes from the lift generated by the wing portions 30A, 30B, and a minority, if any, lift for the aircraft 10 is generated by the aircraft body 20 itself. In this way, any change in lift as a result of a gust causes a more significant direct effect on the movement of the wing portions 30A, 30B than on the aircraft body 20.

In this example, the first wing portion 30A is substantially similar, but the mirror image about a substantially vertical plane aligned with the longitudinal axis L of the aircraft 10, of the second wing portion 30B. The inventors have realised that by careful design of the wing portions when the wing portions are flexibly mounted to the aircraft body 20, reaction forces, such as vertical reaction forces, at the respective wing roots of the wing portions can be reduced, or even substantially eliminated. A reduction of reaction forces at the wing root reduces the movement of the aircraft body 20 because any reaction forces at the wing root are passed to the aircraft body 20. Thus, by reducing the reaction forces at the wing root, variations in lift due to gusts, which can cause movement of the wing portions 30A, 30B, can be at least partially decoupled from vertical movement of the aircraft body 20. Of course, where only one of the wing portions 30A, 30B experiences a change in lift due to a gust, or where each wing portion 30A, 30B experiences a different change in lift, any differing vertical reaction forces at the wing roots can cause roll of the aircraft body 20, which is also undesirable. The inventors have found that one way to reduce or substantially remove vertical reaction forces at the wing roots (and therefore also improve roll stability of the aircraft body 20 in gusts) is to arrange the wing portions 30A, 30B such that a centre of percussion of the wing portion 30A, 30B is at least near, such as within 25% of a length of the wing portion 30A, 30B (from wing root to wing tip), and preferably within 10% of the length of the wing portion 30A, 30B or even substantially co-located with, a centre of pressure of the wing portion 30A, 30B when the aircraft 10 is flying at a predetermined airspeed. In other words, the aircraft 10 is configured such that reaction forces at the mounting between the wing portions 30A, 30B and the aircraft body 20, in this example through the pivot axes 32A, 32B, are reduced significantly, or even substantially eliminated when the aircraft 10 encounters a uniform gust of up to a predetermined maximum gust wind speed compared to an aircraft having the same wing portions and aircraft body, but with a rigid and substantially inflexible mounting between the wing portions and the aircraft body.

It will be understood that the centre of percussion of the wing portion is the point on the wing portion at which an impulse applied thereto would cause no resultant reaction force at the pivot axis 32A, 32B. Of course, there is still likely to be a resultant acceleration of the centre of mass of the wing portion, and also a rotation of the wing portion about the pivot axis 32A, 32B, but these effects cancel at the wing root, resulting in zero reaction force at the pivot axis 32A, 32B. It will be further understood that any gust applied to one or more of the wing portions 30A, 30B, can be approximated as a uniform change in air velocity over the wing portions, independent of length along the wing portion in the along-wing direction. Furthermore, it will be understood that a number of lift forces applied at different points along the wing portion can, for the purposes of calculating reaction forces at the pivot axis of the wing portion, be further approximated as a single combined lifting force applied at a single point on the wing portion.

The centre of pressure of the wing portion is the effective location on the wing portion at which the combined vector forces of lift and drag can be considered to act for a given aircraft situation, including angle of attack, airspeed and gust condition. The inventors have found that if the centre of pressure of the wing portion is found for a target airspeed and angle of attack to maintain a constant altitude of the aircraft 10 (in the absence of any gusts), and if the wing portion is arranged such that the centre of percussion of the wing portion is substantially co-located with, or located within approximately 25% of a length of the wing portion (from wing root to wing tip), of the centre of pressure of the wing portion, the reaction forces at the wing root and therefore passed to the aircraft body 20 are reduced. The closer the centre of pressure is to the centre of percussion, the greater the reduction in the reaction forces at the wing root. Therefore, the aircraft body 20 exhibits reduced variations in vertical movement with gusts, even though there is movement of the wing portions 30A, 30B.

In this example, the centre of percussion (not shown) of each wing portion 30A, 30B is located approximately two thirds of the way from the pivot axis 32A, 32B to the wing tip at the outboard end of each respective wing portion 30A, 30B. Similarly, the centre of pressure for each wing portion 30A, 30B is located approximately halfway between the pivot axis 32A, 32B and the wing tip. In this way, it can be seen that the distance between the centre of percussion and the centre of pressure is just under 17% of the distance from the pivot axis 32A, 32B to the wing tip, with the centre of percussion being outboard of the centre of pressure for each wing portion 30A, 30B. In other words, the wing tip of each wing portion 30A, 30B is closer to the centre of percussion of the respective wing portion 30A, 30B than to the centre of pressure.

The aircraft 10 can also include one or more components requiring a stable mounting during use to be provided or mounted at the aircraft body 20. The one or more components can include one or more sensors (not shown) mounted in a sensor housing 50 provided at the aircraft body 20. The one or more sensors typically include at least an optical image sensor, such as a camera and may include other sensors which require a stable platform to capture high quality sensor telemetry. In the presently disclosed aircraft 10, the one or more sensors, when mounted to the aircraft body 20 require significantly reduced, or even no further stabilisation due to reduced vertical movement and roll of the aircraft body 20 due to gusts, compared to a similarly-sized aircraft having wings rigidly mounted to the aircraft body. As explained hereinbefore, this is due to the flexibly mounted wings 30A, 30B and/or the designed vicinity of the centre of percussion of the wings 30A, 30B with the centre of pressure. The other sensors can include, for example any one or more of a radar sensor, a thermal imaging sensor, or any other sensors as desired. The sensor housing 50 may further include one or more stabilising components, such as a gyroscopic stabiliser. It will be understood that the size, weight, cost, power consumption and/or complexity of the stabilising components will be reduced compared to a similar aircraft having a rigid mounting of the wings to the aircraft body.

In some examples, the one or more components requiring a stable mounting during use may include a landing component, for example a landing hook (not shown) for engaging with a landing system on a landing surface (e.g. the ground or the deck of a ship) during a landing manoeuvre of the aircraft 10.

In some examples, the one or more components requiring a stable mounting during use may include one or more emitters. It will be understood that an emitter is any component which emits heat, light, sound or matter from the aircraft 10. In particular, the emitter can be a targeted emitter. In this way it can be seen that a stable aircraft body 20 is required so that the emitter can accurately target an area away from the aircraft 10. The emitter can include a sound emitter, such as a speaker. The emitter can include a radiation emitter, such as an emitter configured to emit visible light, or electromagnetic radiation in any part of the electromagnetic spectrum. The emitter can be a laser. The emitter can include a matter emitter, that is an emitter configured to emit matter from the aircraft 10, such as a liquid, for example paint or water. As described hereinbefore, the aircraft 10 can also or instead of the sensor housing 50 include a delicate cargo storage area (not shown) in the aircraft body 20 for transporting cargo which requires improved stabilisation.

In some examples, it can be desirable to lock the wing portions 30A, 30B in a predetermined position, so as to prevent undesirable flexing of a mounting of the wing portions 30A, 30B relative to the aircraft body 20. Although not shown, it will be understood that one possible option is to provide a locking mechanism between each wing portion 30A, 30B and the aircraft body 20. The locking mechanism may comprise a locking component which, when activated, rigidly locks each wing portion 30A, 30B to the aircraft body 20. In one example, the locking component comprises a first locking bar configured to extend from the aircraft body 20 to within the first wing portion 30A and a second locking bar configured to extend from the aircraft body 20 to within the second wing portion 30B. The wing portions 30A, 30B are each configured to be rotationally locked relative to the aircraft body 20 when the locking bars are provided therein. It will be understood that alternative systems and components for selectively locking the flexible mounting between the wing portions 30A, 30B and the aircraft body 20 will be apparent to the skilled person. By locking the wing portions 30A, 30B in a predetermined angular position about the pivot axes 32A, 32B, the aircraft 10 can still be configured to respond in an agile way to flight control inputs when necessary. For example, it may be that the locking mechanism can be activated during complex manoeuvres of the aircraft 10, such as for take-off and landing. Alternatively, the locking mechanism can be de-activated during any environments in which gusts are more likely or more problematic, such as flying near the ground during take-off and landing. If a landing component, such as an undercarriage or a landing hook or landing wire of the aircraft 10 is mounted to the aircraft body 20, then it may be useful to substantially reduce unwanted and unpredictable vertical movements of the aircraft body 20 during take-off and landing, even in gusty conditions.

It will be understood that the aircraft 10 can be configured to include one or more rotation stops to substantially prevent rotation of the wing portions 30A, 30B about the pivot axes 32A, 32B beyond predetermined rotation limits, for example less than approximately 30 degrees.

In some examples, components on the aircraft 10 can be redistributed compared to a typical aircraft configuration such that at least some of the components which could otherwise be located in the aircraft body 20 are instead located in the wing portions 30A, 30B. The inventors have found that a more massive wing portion, compared to the mass of the aircraft body, makes the wing portions 30A, 30B able to mitigate against a wider range of gust speeds because it takes a higher gust speed to deflect the wing portion a preset amount. Furthermore, smaller deflections of the wing portions 30A, 30B mean that the centre of pressure of the wing portions 30A, 30B will move less for a given range of gusts, making the performance of the wing portions 30A, 30B more consistent for different wind speeds. For at least these reasons, it will be seen that it is advantageous to install components in the wing portions 32A, 32B which would otherwise be located in the aircraft body 20 in traditional aircraft designs. Of course, by careful design, it will be understood that the location of the centre of percussion on the wing portions 32A, 32B can be arranged to be near, for example substantially co-located with, a centre of pressure for the wing portion. In examples, the components can be provided in the wing portions to move the centre of percussion of the wing portions inwardly towards the wing root than would be the case in the absence of the components. In one example, the additional components can be located approximately 20%-30% of the way from the wing root to the wing tip in the wing portions. It will be understood that the centre of pressure of the wing portion is typically a function of the shape of the outer surface of a wing portion, and has little or even no dependence on the mass distribution of the internal structure of the wing portion.

FIGS. 2 and 3 are illustrations of the aircraft 10 as depicted in FIG. 1, viewed from a side-on orientation and a top-down orientation respectively. As can be seen, the second wing portion 30B shown in FIG. 2 has a substantially uniform aerofoil profile of a type known to generate lift when the aircraft 10 is moved through a medium in the forward direction F. It will be understood that the aerofoil design shown in the Figures is merely an example aerofoil design and any other suitable aerofoil design can be used or even designed as required to generate lift and other operating characteristics of the wing portions 30A, 30B without departing from the inventive concepts disclosed herein.

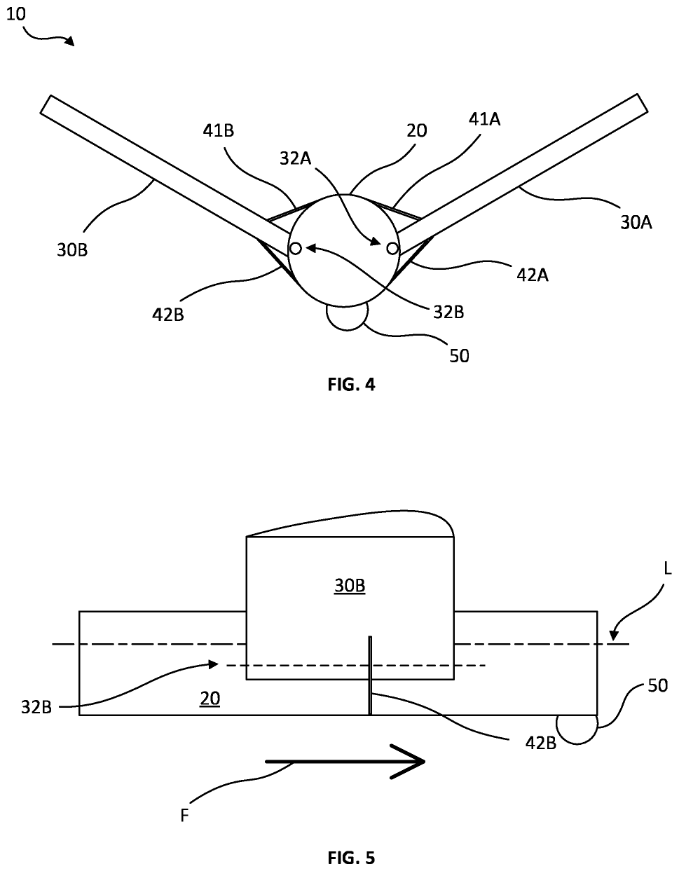

FIGS. 4 and 5 are further illustrations of the aircraft 10 shown in FIGS. 1 to 3, provided in a deflected configuration and viewing in a head-on and side-on orientation respectively. Although FIGS. 4 and 5 show both wing portions 30A, 30B deflected upwards, it will be understood that in some examples, only one wing portion may be deflected. In the case that only one wing portion is deflected, the present disclosure still provides substantially the same benefits, because the reaction at the pivot axes 32A, 32B will be reduced, for example substantially eliminated, reducing or even substantially elimination any vertical movement and/or roll of the aircraft body 20.

Although the specification has described gusts as a cause of variations in lift generated by a wing or a portion of the wing, it will be understood that other phenomena may cause variations in the lift generated by the wing or the portion of the wing, such as turbulence from other aircraft, amongst others.

Although not shown, it will be understood that the aircraft 10 can also include one or more electrical systems, including a propulsion generation system, an energy storage system, a control system, and a communication system. The propulsion generation system can include one or more of engines, propellers, rotors, jets, and any other propulsive units. The energy storage system can include one or more of a fuel tank and batteries. The control system can include a controller for controlling one or more electrical components of the aircraft. The communication system can include a transceiver for receiving one or more control instructions for control of the aircraft, and/or for transmitting out of the aircraft status information of the systems and status of the aircraft, such as speed, heading, altitude, location, energy level, such as fuel level, and any other required status information. The one or more electrical systems may be located in the wing portions.

Where appropriate, the presently disclosed concepts for passive mitigation of the effects of gusts on aircraft can be combined with active techniques for mitigation of the effects of gusts on aircraft. For example, a pitch of the wing portions of the aircraft can be changed actively or passively to alter the angle of attack of one or both of the wing portion, whereby to actively compensate for any increase in wind speed due to a gust and reduce, or even substantially eliminate any vertical height response, or roll response, of the aircraft body to the gust. In one example, the aircraft can be configured to change the pitch of the wing portions of the aircraft in dependence on the deflection of the wing portions. For example, where the wing portion is deflected upward, the pitch of the wing can be reduced to reduce an angle of attack of the wing portion and reduce the lift generated by the wing portion, which can act to return the wing portion towards the equilibrium position. The change in the pitch of the wing portions can be achieved by application of the further force to the wing portion. Similarly, when the wing is deflected downward, the pitch of the wing portion can be increased to increase an angle of attack of the wing portion and increase the lift generated by the wing portion, which can act to return the wing portion towards the equilibrium position. In some examples, the lift force generated by the wing portions can change from the second lift value towards and beyond the first lift value to a third lift value. In other words, if the second lift value is greater than the first lift value, the third lift value is below the first lift value. Subsequently, a second further force can be applied to the wing portion to further change the lift force generated by the wing portions, for example by changing the pitch (sometimes referred to as the angle of attack) of the wing portions, back towards the first lift value. The second further force is typically applied as the wing portion returns to the equilibrium position.

Either or both of the further force and the second further force, where present, can be generated passively in response to deflection of the wing portions. Conversely, in some examples, either or both of the further force and the second further force, where present, can be generated actively, for example by a powered actuator in response to sensing a change in deflection or lift generated by the wing portions. Implementations of mechanical systems to generate the further force and the second further force passively or actively will be apparent to the skilled person.

Although portions of the present disclosure relate to a single winged aircraft, otherwise referred to as a monoplane, it will be understood that the inventive concepts disclosed herein can equally be applied to other wing configurations, such as biplanes having two wings, or triplanes having three wings, or any other suitable configuration of aircraft where a mechanical linkage between the wing and the aircraft body can cause movement of the aircraft body as a result of rapidly changing atmospheric conditions, such as gusts of wind.

In summary, there is provided an aircraft (10) for flying in a forward direction (F). The aircraft (10) comprises an aircraft body (20), and a wing comprising a first wing portion (30A) and a second wing portion (30B). The first wing portion (30A) and the second wing portion (30B) extend away from the aircraft body (20). The first wing portion (30A) and the second wing portion (30B) are configured to generate a first lift value during level flight of the aircraft (10) in the forward direction (F) when the first wing portion (30A) and the second wing portion (30B) are in an equilibrium position. Each of the first wing portion (30A) and the second wing portion (30B) is flexibly mounted relative to the aircraft body (20) such that when a lift force generated by the first wing portion (30A) changes from the first lift value to a second lift value, the first wing portion (30A) is deflected substantially vertically away from an equilibrium position. The aircraft (10) is configured to provide a further force to the first wing portion (30A) to substantially prevent further deflection of the first wing portion (30A) away from the equilibrium position.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An aircraft for flying in a forward direction, the aircraft comprising:
an aircraft body; and
a wing comprising a first wing portion and a second wing portion each extending away from the aircraft body, the first wing portion and the second wing portion configured to generate a first lift value during level flight of the aircraft in the forward direction when the first wing portion and the second wing portion are in an equilibrium position, wherein each of the first wing portion and the second wing portion is flexibly mounted relative to the aircraft body such that when a lift force generated by the first wing portion changes from the first lift value to a second lift value, the first wing portion is deflected substantially vertically away from the equilibrium position,
wherein the aircraft is configured to provide a further force to the first wing portion to substantially prevent further deflection of the first wing portion away from the equilibrium position.

2. The aircraft of claim 1, wherein each of the first wing portion and the second wing portion has a wing root and a wing tip, and a wing length defining a distance between the wing root and the wing tip in the along-wing direction, and
wherein the first wing portion is configured such that, during flight, a distance between a centre of percussion and a centre of pressure of the first wing portion in the along-wing direction is less than 25% of the wing length.

3. The aircraft of claim 2, wherein each of the first wing portion and the second wing portion is configured such that a first distance between the centre of percussion of the respective wing portion and the wing root is greater than a second distance between the centre of pressure of the respective wing portion and the wing root.

4. The aircraft of claim 2, wherein the first wing portion is configured such that the centre of percussion is substantially co-located with the centre of pressure of the first wing portion.

5. The aircraft of claim 1, wherein the aircraft defines a longitudinal axis between a nose and a tail of the aircraft, wherein the first wing portion is pivotably mounted relative to the aircraft body about a pivot axis substantially parallel to the longitudinal axis and at a wing root of the first wing portion, and wherein the further force for the first wing portion is provided when the first wing portion is rotated about the pivot axis away from the equilibrium position.

6. The aircraft of claim 5, further comprising at least one rotation stop configured to substantially constrain rotation of the first wing portion about the pivot axis to be within a predetermined rotation range.

7. The aircraft of claim 1, wherein the further force is a balancing force to substantially prevent any further deflection of the first wing portion away from the equilibrium position when the lift force generated by the first wing portion returns to the first lift value.

8. The aircraft of claim 7, wherein the further force is a restoring force to move the first wing portion back towards the equilibrium position when the lift force generated by the first wing portion returns towards the first lift value.

9. The aircraft of claim 8, further comprising at least one resiliently deformable member connecting the aircraft body to the first wing portion and configured to provide the restoring force.

10. The aircraft of claim 1, wherein the further force is configured to change a lift force generated by the first wing portion from the second lift value towards and past the first lift value to return the first wing portion back towards the equilibrium position.

11. The aircraft of claim 10, wherein the aircraft is configured to provide a second further force to the first wing portion as the first wing portion returns to the equilibrium position to change the lift force generated by the first wing portion to the first lift value.

12. The aircraft of claim 1, further comprising one or more sensors, mounted at the aircraft body.

13. The aircraft of claim 12, wherein the one or more sensors comprise at least one of a camera, a thermal imaging sensor and a radar sensor.

14. The aircraft of claim 1, further comprising one or more emitters, mounted at the aircraft body.

15. The aircraft of claim 14, wherein the one or more emitters comprise at least one of a sound emitter, a radiation emitter and a matter emitter.

16. The aircraft of claim 1, further comprising a locking mechanism configured to, when activated, secure the first wing portion in the equilibrium position, whereby to prevent deflection of the first wing portion away from the equilibrium position.

17. The aircraft of claim 1, further comprising one or more further components, located in the first wing portion, whereby to increase a mass of the first wing portion relative to the aircraft body.

18. The aircraft of claim 17, wherein the one or more further components are provided in the first wing portion at a distance approximately 30% from the wing root to the wing tip.

19. The aircraft of claim 1, wherein the further force is passively provided.

20. The aircraft of claim 1, wherein the aircraft is an unmanned aerial vehicle, UAV.

21. The aircraft of claim 1, wherein the second wing portion comprises substantially the same features as the first wing portion.

22. A kit of parts for assembling the aircraft of claim 1, the kit comprising:
an aircraft body; and
a first wing portion and a second wing portion each configured to be attached to the aircraft body to extend away from the aircraft body for generating a first lift value during level flight of the assembled aircraft in the forward direction when the first wing portion and the second wing portion are in an equilibrium position, wherein each of the first wing portion and the second wing portion is configured to be flexibly mounted relative to the aircraft body such that when a lift force generated by the first wing portion changes from the first lift value to a second lift value, the first wing portion is deflected substantially vertically away from the equilibrium position,
wherein the assembled aircraft is configured to provide a further force to the first wing portion to substantially prevent further deflection of the first wing portion away from the equilibrium position.
